(19) United States
(12) Patent Application Publication
(10) Pub. No.: US 2020/0358734 A1
(43) Pub. Date: Nov. 12, 2020

(54) MEDIUM, INFORMATION PROCESSING METHOD, AND INFORMATION PROCESSING APPARATUS

(71) Applicant: LINE Corporation, Tokyo (JP)

(72) Inventors: Kazutaka IRIE, Tokyo (JP); Lisandi KURNIAWAN, Tokyo (JP); Luke CARWARDINE, Tokyo (JP); KyoungJin KIM, Seongnam-si (KR); Vincent PERICART, Tokyo (JP); Dayoung KIM, Seongnam-si (KR)

(73) Assignee: LINE Corporation, Tokyo (JP)

(21) Appl. No.: 16/940,608

(22) Filed: Jul. 28, 2020

Related U.S. Application Data
(63) Continuation of application No. PCT/JP2018/045982, filed on Dec. 13, 2018.

(30) Foreign Application Priority Data
Jan. 30, 2018 (JP) 2018-014030

(51) Int. Cl. H04L 12/58; G06F 3/14; G06F 13/38

(52) U.S. Cl. CPC H04L 51/22; G06F 2213/40; G06F 13/38; G06F 3/14

(57) ABSTRACT

A non-transitory computer-readable recording medium has computer-readable instructions stored thereon, which when executed, cause an information processing apparatus that includes a memory and a processor, to execute a process. The process includes receiving a first content in a first group including a first user and a second user, displaying one or more contents including the first content transmitted and received in the first group on a screen, and hiding the first content from among the one or more contents transmitted and received in the first group in response to receiving a request to cancel transmission of the first content from the first user.

### CROSS-REFERENCE TO RELATED APPLICATIONS

This U.S. non-provisional application is a continuation application of, and claims the benefit of priority under 35 U.S.C. § 365(c) from, PCT International Application PCT/JP2018/045982 filed on Dec. 13, 2018, which designated the U.S., and is based upon and claims the benefit of priority of Japanese Patent Application No. 2018-014030 filed on Jan. 30, 2018, the entire contents both of which are incorporated herein by reference.

### BACKGROUND

### Field

The present disclosure relates to mediums, information processing methods, and/or an information processing apparatuses.

### Description of related art

Conventionally, after a mail has been transmitted from one terminal to a mail server, the mail server deletes the mail in response to a request from the one terminal before the mail is delivered to a destination terminal

Also, in recent years, communication traffic using instant messaging services (IMS) has been increasing.

However, in the conventional techniques, in the instant messaging services and the like, when a content such as a message or the like is wrongly transmitted in a group that includes multiple users, there has been a problem that the content received on a terminal of one user cannot be deleted by an operation or the like performed on a terminal of another user.

### SUMMARY

According to an example embodiment in the present disclosure, a non-transitory computer-readable recording medium has computer-readable instructions stored thereon, which when executed, cause an information processing apparatus that includes a memory and a processor, to execute a process. The process includes receiving a first content in a first group including a first user and a second user, displaying one or more contents including the first content transmitted and received in the first group on a screen, and hiding the first content from among the one or more contents transmitted and received in the first group in response to receiving a request to cancel transmission of the first content from the first user.

According to an example embodiment in the present disclosure, a non-transitory computer-readable recording medium has computer-readable instructions stored thereon, which when executed, cause an information processing apparatus that includes a memory and a processor, to execute a process. The process includes receiving a first content in a first group including a first user and a second user via another information processing apparatus connected via a network, storing the first content, and displaying one or more contents including the first content transmitted and received in the first group on a screen, and deleting the first content that has been stored, in response to receiving a request to cancel transmission of the first content from the first user.

According to an example embodiment in the present disclosure, a non-transitory computer-readable recording medium has computer-readable instructions stored thereon, which when executed, cause an information processing apparatus that includes a memory and a processor, to execute a process. The process includes transmitting or receiving a first content in a first group including a first user and a second user via another information processing apparatus connected via a network, transmitting a request to cancel transmission of the first content from the first user, via said another information processing apparatus, and deleting the first content that has been stored, from among one or more contents transmitted and received in the first group, in response to receiving the request to cancel the transmission from said another information processing apparatus.

According to an example embodiment in the present disclosure, an information processing method performed by an information processing apparatus including a memory and a processor includes receiving a first content in a first group including a first user and a second user, displaying one or more contents including the first content transmitted and received in the first group on a screen, and hiding the first content from among the one or more contents transmitted and received in the first group in response to receiving a request to cancel transmission of the first content from the first user.

According to an example embodiment in the present disclosure, an information processing apparatus includes a memory configured to store computer-readable instructions, and a processor configured to execute the computer-readable instructions such that the processor is configured to cause the information processing apparatus to receive a first content in a first group including a first user and a second user, display one or more contents including the first content transmitted and received in the first group on a screen, and hide the first content from among the one or more contents transmitted and received in the first group in response to receiving a request to cancel transmission of the first content from the first user.

### BRIEF DESCRIPTION OF DRAWINGS

FIG. 1 is a diagram illustrating a configuration of a communication system according to an example embodiment of the present disclosure;

FIG. 2 is a sequence chart illustrating an example of processing in a communication system according to an example embodiment in the present disclosure;

FIG. 3A is a diagram illustrating an example of a talk room screen displayed on a terminal;

FIG. 3B is a diagram illustrating an example of a talk room screen displayed on a terminal;

FIG. 3C is a diagram illustrating an example of a talk room screen displayed on a terminal;

FIG. 3D is a diagram illustrating an example of a talk room screen displayed on a terminal;

FIG. 3E is a diagram illustrating an example of a talk room screen displayed on a terminal;

FIG. 4 is a flow chart illustrating an example of a process of canceling transmission of a received content according to an example embodiment in the present disclosure.

FIG. 5 is a diagram illustrating an example of a notice badge on a home screen of a terminal.

FIG. 6A is a diagram illustrating an example of a list screen of talk rooms displayed on a terminal;

FIG. 6B is a diagram illustrating an example of a list screen of talk rooms displayed on a terminal;

FIG. 6C is a diagram illustrating an example of a list screen of talk rooms displayed on a terminal;

FIG. 7 is a flow chart illustrating an example of a process of determining whether to permit cancellation of transmission according to an example embodiment in the present disclosure;

FIG. 8 is a diagram illustrating an example of account information; and

FIG. 9 is a flow chart illustrating an example of a process of determining whether to permit cancellation of transmission according to an example embodiment in the present disclosure.

### DETAILED DESCRIPTION

<Observance of Legal Matters>

It should be noted that the disclosure described in the present specification assumes compliance with the laws of the jurisdiction required in any country where the subject matter of the present disclosure is implemented, such as the confidentiality of communication.

In the following, some example embodiments for implementing a program and the like according to the present disclosure will be described with reference to the drawings.

According to some example embodiment, techniques are provided that enable to delete a content received on a terminal of one user included in a group by an operation performed on a terminal of another user included in the group.

<System Configuration>

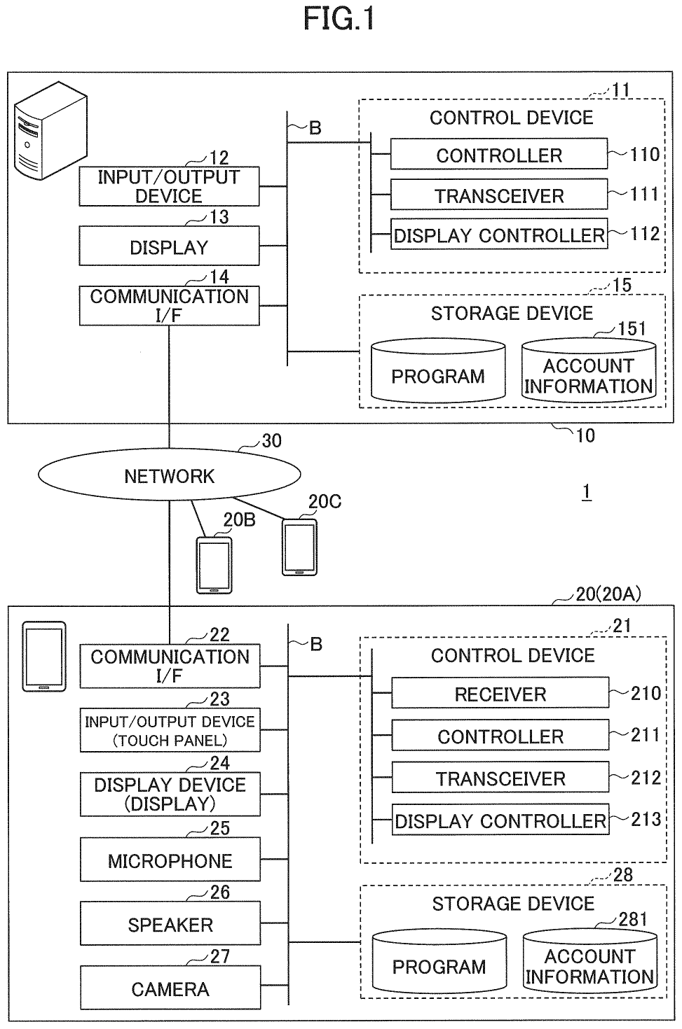

FIG. 1 illustrates a configuration of a communication system 1 according to an example embodiment of the present disclosure. As illustrated in FIG. 1, in the communication system 1, a server 10, and terminals 20 (terminal 20A, terminal 20B, and terminal 20C), are connected via a network 30. The server 10 provides a service that implements transmission and reception of messages between the terminals 20 to a terminal 20 used by a user via the network 30. Note that the number of terminals 20 connected to the network 30 is not limited.

The network 30 plays a role of connecting one or more terminals 20 with one or more servers 10. In other words, the network 30 means a communication network that provides a connection path through which a terminal 20 can transmit and receive data after connecting to a server 10.

One or more parts of the network 30 may be a wired network and/or a wireless network. The network 30 may include, by way of example but not as a limitation, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile phone network, integrated service digital networks (ISDNs), wireless LANs, long term evolution (LTE), code division multiple access (CDMA), Bluetooth (registered trademark), satellite communication, and a combination of two or more of these. The network 30 may also include one or more networks.

The terminal 20 (terminal 20A, terminal 20B, or terminal 20C) may be any terminal as long as it can implement functions described in the embodiment. The terminals 20 may include, by way of example but not as a limitation, a smart phone and may also be a mobile phone (feature phone), a computer (by way of example but not as a limitation, a desktop-type, a laptop-type, a tablet-type, etc.), a media computer platform (by way of example but not as a limitation, a cable/satellite TV set-top box, a digital video recorder, etc.), a handheld computing device (by way of example but not as a limitation, a PDA (personal digital assistant), an e-mail client, etc.), a wearable terminal (a glasses-type device, a watch-type device, etc.), or any other type of a computer or a communication platform. The terminal 20 may be expressed as an information processing terminal.

The configurations of the terminal 20A, the terminal 20B, and the terminal 20C are basically the same. Therefore, in the following description, any of these may be referred to as the terminal 20. Note that user information is information on a user associated with an account used by the user in a desired (or alternatively,) service. The user information includes information associated with the user that is entered by the user or given by the desired (or alternatively, predetermined) service, and includes, by way of example but not as a limitation, a name of the user, an icon (moving image) of the user, the age of the user, the gender of the user, an address of the user, a hobby of the user, and an identifier of the user, and the like, or any one or a combination of these.

The server 10 has a function of providing a desired (or alternatively, desired (or alternatively, predetermined)) service to the terminal 20. The server 10 may be any type of information processing apparatus as long as it can implement functions described in the embodiment. The server 10 may include, by way of example but not as a limitation, a server device, a computer (e.g., a desktop-type, a laptop-type, a tablet-type, etc.), a media computer platform (by way of example but not as a limitation, a cable/satellite TV set-top box, a digital video recorder, etc.), a handheld computing device (by way of example but not as a limitation, a PDA (personal digital assistant), an e-mail client, etc.), or any other type of a computer or a communication platform. The server 10 may be expressed as an information processing apparatus. In the case where it is not necessary to distinguish a server 10 and a terminal 20, the server 10 or the terminal 20 may be referred to as an information processing apparatus.

### <Hardware (HW) Configuration>

With reference to FIG. 1, a HW configuration of each device included in the communication system 1 will be described.

(1) HW Configuration of Terminal

The terminal 20 includes a control device 21 (a CPU: Central Processing Unit), a storage device 28, a communication I/F 22 (an interface), an input/output device 23, a display device 24, a microphone 25, a speaker 26, and a camera 27. These elements of the HW of the terminal 20 are connected to each other, by way of example but not as a limitation, via a bus B.

The communication I/F 22 transmits and receives various items of data via the network 30. The communication may be executed by wire and/or by radio, and any communication protocol may be used as long as mutual communication can be executed. The communication I/F 22 has a function of performing communication with the server 10 via the network 30. The communication I/F 22 transmits various items of data to the server 10 according to a command from the control device 21. Also, the communication I/F 22 receives various items of data transmitted from the server and transfers the received data items to the control device 21.

The input/output device 23 includes a device for inputting various operations on the terminal 20 and a device for outputting processed results processed on the terminal 20. The input/output device 23 may have an input device and an output device integrated, or have an input device and an output device separated.

The input device is implemented by any one of all types of devices or a combination of these devices that can receive input from the user and transmit information related to the input to the control device 21. The input device includes, by way of example but not as a limitation, a touch panel, a touch display, hardware keys such as a keyboard or the like, a pointing device such as a mouse, a camera (operation input via moving images), and a microphone (operation input by voice).

The output device is implemented by any one or a combination of all types of devices capable of outputting processed results processed by the control device 21. The output device includes, by way of example but not as a limitation, a touch panel, a touch display, a speaker (audio output), a lens (by way of example but not as a limitation, 3D (three dimensional) output or hologram output), a printer, and the like.

The display device 24 is implemented by any one of all types of devices or a combination of these that can execute displaying according to display data written in a frame buffer. The display device 24 includes, by way of example but not as a limitation, a touch panel, a touch display, a monitor (by way of example but not as a limitation, a liquid crystal display or an OELD (organic electroluminescence display)), a head-mounted display (HMD), projection mapping, hologram, or a device that is capable of displaying images, text information, and the like in the air or the like (which may be a vacuum). Note that these display devices 24 may be capable of displaying display data in 3D.

In the case where the input/output device 23 is a touch panel, the input/output device 23 and the display device 24 may have substantially the same size and shape to be arranged to face each other.

The control device 21 has a circuit that is physically structured to execute functions implemented by codes or instructions included in a program, and is implemented by, by way of example but not as a limitation, a data processing device built in the hardware.

The control device 21 includes, by way of example but not as a limitation, a central processing unit (CPU), and also may be a microprocessor, a processor core, multiprocessors, an ASIC (application-specific integrated circuit), or an FPGA (field programmable gate array).

The storage device 28 has a function of storing various programs and various items of data required when the terminal 20 operates. The storage device 28 includes, by way of example but not as a limitation, various storage media such as an HDD (hard disk drive), an SSD (solid state drive), a flash memory, a RAM (random access memory), a ROM (read-only memory), and the like.

In the terminal 20, a program P is stored in the storage device 28, and the control device 21 running this program P executes processes corresponding to respective functional units included in the control device 21. In other words, the program P stored in the storage device 28 implements the functions executed by the control device 21 on the terminal 20.

The microphone 25 is used for inputting audio data. The speaker 26 is used for outputting audio data. The camera 27 is used for obtaining data of moving images.

(2) HW Configuration of Server

The server 10 includes a control device 11 (a CPU), a storage device 15, a communication I/F 14 (an interface), an input/output device 12, and a display 13. These elements of the HW of the server 10 are mutually connected, by way of example but not as a limitation, via a bus B.

The control device 11 has a circuit that is physically structured to execute functions implemented by codes or instructions included in a program, and is implemented by, by way of example but not as a limitation, a data processing device built in the hardware.

The control device 11 is typically a central processing unit (CPU), and may be a microprocessor, a processor core, multiprocessors, an ASIC, or an FPGA. However, in the present disclosure, the control device 11 is not limited to these in the present disclosure.

The storage device 15 has a function of storing various programs and various items of data required for the server 10 to operate. The storage device 15 is implemented by various storage media such as an HDD, an SSD, a flash memory, and the like. However, in the present disclosure, the storage device 15 is not limited to these.

The communication I/F 14 transmits and receives various items of data via the network 30. The communication may be executed by wire and/or by radio, and any communication protocol may be used as long as mutual communication can be executed. The communication I/F 14 has a function of executing communication with the terminal 20 via the network 30. The communication I/F 14 transmits various items of data to the terminal 20 according to an instruction from the control device 11. Also, the communication I/F 14 receives various items of data transmitted from the terminal 20, and transmits the data to the control device 11.

The input/output device 12 is implemented by a device that inputs various operations on the server 10. The input/output device 12 is implemented by any one of all types of devices or a combination of these devices that can receive input from the user and can transmit information related to the input to the control device 11. The input/output device 12 is typically implemented by hardware keys represented by a keyboard or the like, a pointing device such as a mouse, and the like. Note that the input/output device 12 may include, by way of example but not as a limitation, a touch panel, a camera (operation input via moving images), and a microphone (operation input by voice). However, in the present disclosure, the input/output device 12 is not limited to these.

The display 13 is typically implemented by a monitor (by way of example but not as a limitation, a liquid crystal display or an OELD (organic electroluminescence display)). Note that the display 13 may be a head-mounted display (HMD) or the like. Note that these displays 13 may be capable of displaying display data in 3D. However, in the present disclosure, the display 13 is not limited to these.

In the server 10, the program P is stored in the storage device 15, and the control device 11 running this program P executes processes corresponding to respective functional units included in the control device 11. In other words, the program P stored in the storage device 15 implements the functions executed by the control device 11 on the server 10.

Each embodiment in the present disclosure will be described assuming that it is implemented by the CPU(s) of the terminal 20 and/or the server 10 executing the program P.

The control device 21 of the terminal 20 and/or the control device 11 of the server 10 may be implemented not only by a CPU but also by a logic circuit (hardware) or a dedicated circuit formed in an integrated circuit (IC) chip, an LSI (Large-Scale Integration) chip, or the like. Also, these circuits may be implemented by one or more integrated circuits, and multiple processes described in the embodiment may be implemented by a single integrated circuit. LSI may also be referred to as VLSI, super LSI, ultra LSI, or the like depending on the degree of integration.

The program P (software program/computer program) of the embodiments in the present disclosure may be provided in a state stored in a computer-readable recording medium. The recording medium can store the program in a “non-transitory tangible medium.”

When appropriate, the recording medium may include one or more semiconductor-based or other integrated circuits (ICs) (by way of example but not as a limitation, field programmable gate arrays (FPGAs) or application specific integrated circuits (ASICs)), a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, any other suitable recording medium, or any suitable combination of two or more of these. When appropriate, the recording medium may be volatile, non-volatile, or may have a combination of volatility and non-volatility. Note that the recording medium is not limited to these examples, and may be any device or medium as long as it can store the program P.

The server 10 and/or the terminal 20 can read the program P stored in the recording medium and execute the read program P to implement the functions of multiple functional units described in each embodiment.

The program P in the present disclosure may be provided to the server 10 or the terminal 20 via any transmission medium (a communication network, a broadcasting wave, or the like) capable of transmitting the program. The server 10 and/or the terminal 20 implement functions of multiple functional units described in the respective example embodiments by executing the program P downloaded via, by way of example but not as a limitation, the Internet or the like.

Each embodiment in the present disclosure can also be implemented in a form of a data signal embedded in a carrier wave in which the program P is embodied by electronic transmission.

At least part of the processes executed on the server 10 and/or the terminal 20 may be implemented by cloud computing constituted with one or more computers.

At least part of the processes executed on the terminal 20 may be executed on the server 10. In this case, the server 10 may be configured to perform at least part of processing executed by the functional units of the control device 21 of the terminal 20.

The terminal 20 may be configured to perform at least part of processing executed on the server 10. In this case, the server 10 may be configured to perform at least part of processing executed by the functional units of the control device 11 of the terminal 20.

Unless explicitly mentioned otherwise, in an example embodiment in the present disclosure, a determination is not configured to be mandatory, and desired (or alternatively, predetermined) processing may be performed if the determination condition is satisfied or desired (or alternatively, predetermined) processing may be performed if the determination condition is not satisfied.

Note that a program in the present disclosure is implemented using, by way of example but not as a limitation, a scripting language such as ActionScript or JavaScript (registered trademark), an object-oriented language such as Objective-C or Java (registered trademark), a markup language such as HTML5, or the like.

Some example embodiments of the present disclosure allow one of the users included in a group to delete a content received on a terminal 20 of another user included in the group.

### <Functional Configuration>

(1) Functional Configuration of Terminal

As illustrated in FIG. 1, the terminal 20 stores account information 281 that includes data related to the user of the terminal 20 in the storage device 28. The account information 281 includes, for example, only the data related to the user of the terminal 20, among data of users of the respective terminals included in the account information 151 stored on the server 10.

As illustrated in FIG. 1, the terminal 20 has a receiver 210, a controller 211, a transceiver 212, and a display controller 213, as functional units implemented by the control device 21.

The receiver 210 receives various operations from the user of the terminal 20. The receiver 210 receives, for example, an operation of canceling transmission of a content that has already been transmitted and received in a group that includes multiple users. Note that “canceling transmission” means hiding the content by deleting at least one of the displayed content and the record of the content, for example, not only on the terminal 20 that received the operation of canceling transmission of the content, but also on the terminal 20 that received the content.

The controller 211 performs various processes for, for example, using an instant messaging service of an SNS (Social Networking Service) provided on the server 10. For example, in response to receiving an operation of canceling transmission of a desired (or alternatively, predetermined) content by the receiver 210, the controller 211 transmits a request to cancel the transmission of the desired (or alternatively, predetermined) content to the server 10 via the transceiver 212. Also, for example, in response to receiving a request to cancel transmission of a desired (or alternatively, predetermined) content from the server 10, the controller 211 causes the display controller 213 or the storage device 28 to delete the desired (or alternatively, predetermined) content.

The transceiver 212 transmits and receives various contents with the other terminals 20 via the server 10 in a group that includes multiple users.

The display controller 213 controls displaying on the screen of the terminal 20 according to a command from the controller 211 or the display controller 112 of the server 10.

(2) Functional Configuration of Server

As illustrated in FIG. 1, the server 10 stores account information 151 that includes data related to the user of each terminal 20 in the storage device 15. Data stored in the account information 151 will be described later.

As illustrated in FIG. 1, the server 10 has a controller 110, a transceiver 111, and a display controller 112, as functional units implemented by the control device 11.

For example, the controller 110 performs various processes for providing an instant messaging service in an SNS. For example, in response to receiving a request to cancel transmission of a content transferred to the terminal of one user, from a terminal 20 of another user, the controller 110 deletes the content stored on the terminal 20 of the one user.

The transceiver 111 transfers a content such as a message, stamp, moving image, and sound received from a terminal 20 in a group that includes multiple users, by the instant messaging service or the like.

According to a command from the controller 110, the display controller 112 controls the screen on the terminal 20 to display a display screen such as a talk room screen in the instant messaging service or the like.

### <Processes>

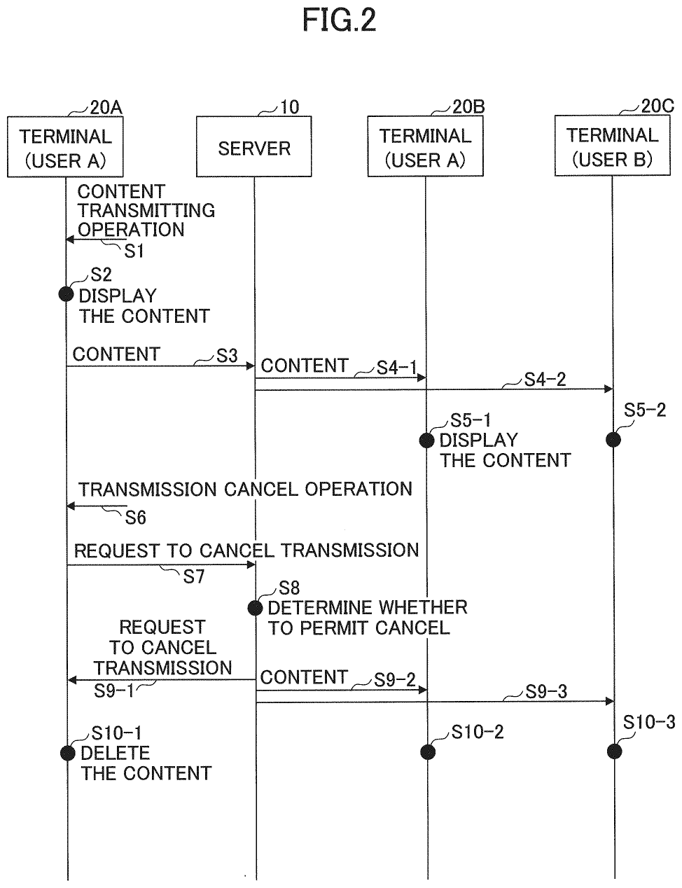

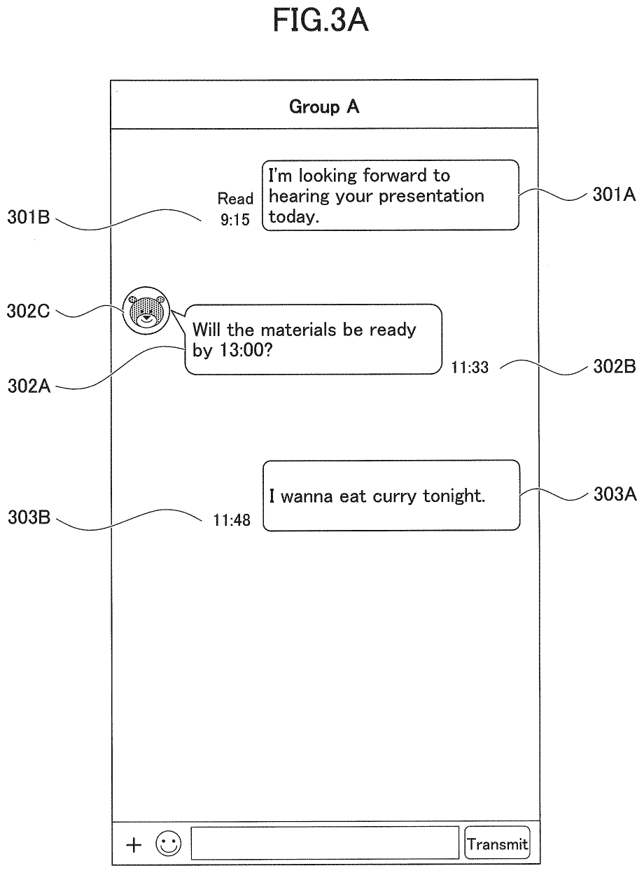

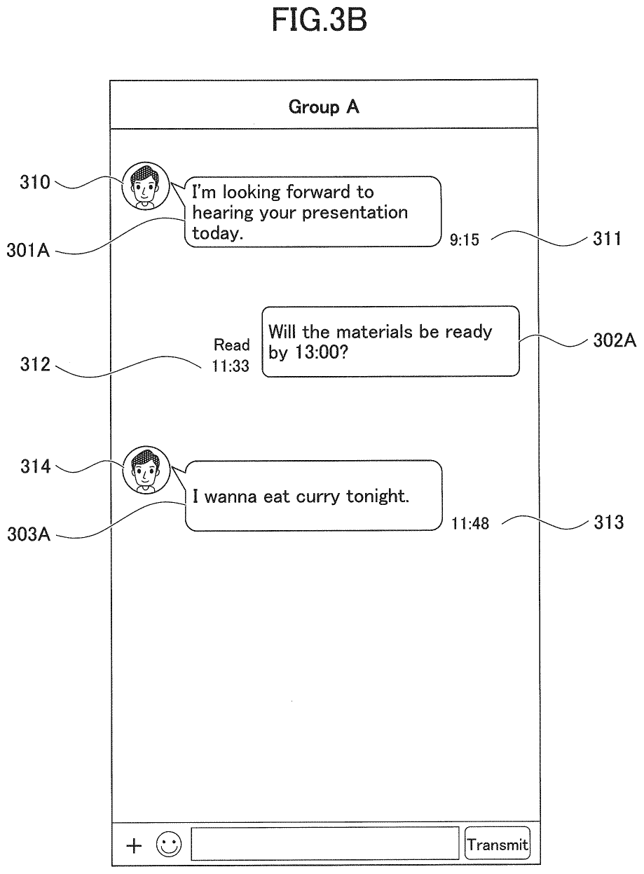

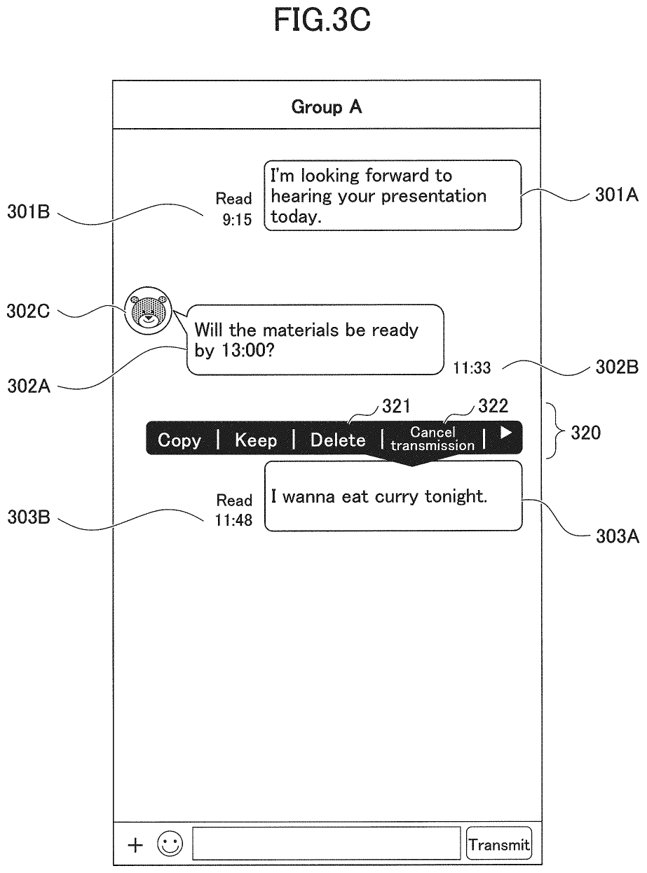

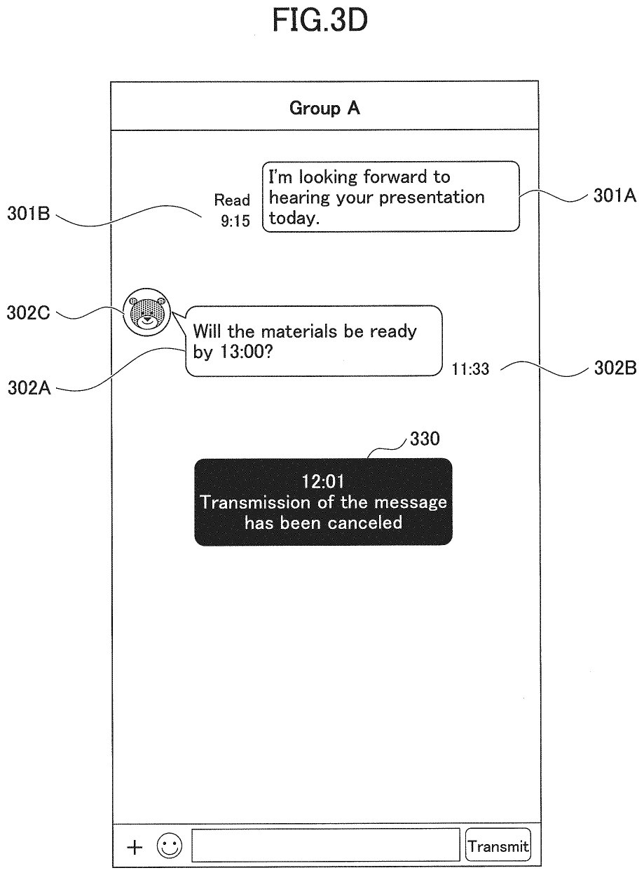

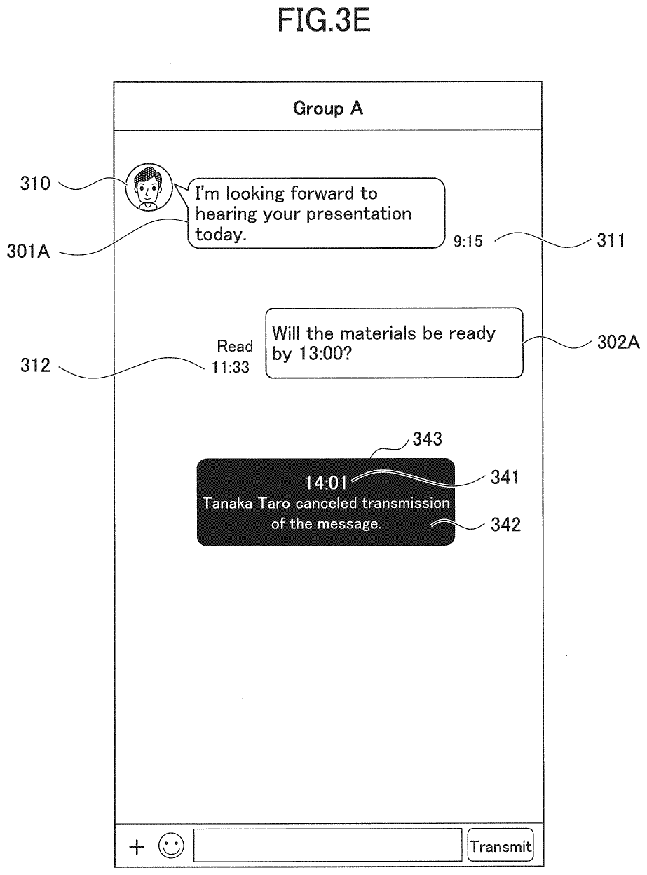

Next, with reference to FIGS. 2 and 3A through 3E, processing executed in the communication system 1 will be described. FIG. 2 is a sequence chart illustrating an example of processing in the communication system 1 according to an example embodiment in the present disclosure. FIGS. 3A through 3E illustrate examples of talk room screens displayed on the terminal 20.

In the following description, it will be assumed that the user of the terminal 20A and the terminal 20B is a user A (an example of a “first user”), and the user of the terminal 20C is a user B (an example of a “second user”). Note that the terminal 20A may be, for example, a smart phone or the like, and the terminal 20B may be, for example, a personal computer or the like. When the user A activates an application for an instant messaging service on the terminal 20A or terminal 20B, the activated terminal 20A or terminal 20B obtains data, such as a latest message, from the server 10. In the case where the application has been activated on both the terminal 20A and the terminal 20B, data such as the latest message is obtained from the server 10 on the terminal 20A and the terminal 20B.

Note that in the following, although an example will be described in which transmission of a content transmitted by the user A is canceled by an operation performed by the user A, transmission of a content transmitted by the user B may be canceled by the user A performing a similar operation.

Note that in the following, among users included in a group related to a talk room, users other than a user who transmitted a content will be referred to as “the other users.”

At Step S1, on the talk room screen of a predetermined (or alternatively, desired) group including the user A and the user B (the “first group”), the receiver 210 of the terminal 20A receives an operation of transmitting a content (“first content”) from the user A.

Next, at Step S2, the display controller 213 of the terminal 20A controls the content to be displayed right-aligned on the talk room screen of the desired (or alternatively, predetermined) group.

Note that on the talk room screen, contents transmitted and received within the desired (or alternatively, predetermined) group are displayed in order of transmitted and received date and time. In diagrams illustrating display examples of talk room screens in FIG. 3A and the like, on each of the talk room screens of the terminal 20, contents transmitted from the terminal 20 are displayed right-aligned, and contents received from the other terminals 20 via the server 10 are associated with icons of the respective users of the other terminals 20, and displayed left-aligned. Also, on the talk room screen of the terminal 20, a string of “Read” is displayed in association with each transmitted/received content, to indicate the date and time when the content was transmitted/received, and that the content was displayed on the talk room screen of the terminal 20 of the other user. In the case where the group related to a talk room includes three or more users, the number of the other users who have displayed the content may also be displayed as “Read 1” or “Read 2.”

FIG. 3A illustrates an example of a talk room screen displayed on the terminal 20A. In the example in FIG. 3A, a message 301A and a message 303A are messages transmitted by the user A, and a message 302A is a message transmitted by the user B. Additional information 301B, additional information 302B, and additional information 303B are additional information items showing the dates and times when the message 301A, the message 302A, and the message 303A were transmitted, respectively. An icon 302C associated with the message 302A is an icon indicating the user B who transmitted the message 302A.

Next, at Step S3, the transceiver 212 of the terminal 20A transmits the desired (or alternatively, predetermined) content via the server 10 to the desired (or alternatively, predetermined) group specified by the user A. Here, the transceiver 212 of the terminal 20A may transmit to the server 10 the content, together with the ID of the destination group or the ID of each user included in the destination group, and the ID of the user who transmitted the content.

Next, at Step S4-1 and Step S4-2, the transceiver 111 of the server 10 forwards the content to the terminal 20B and the terminal 20C other than the terminal 20A, which is the sender of the content, among the terminal 20A, the terminal 20B, and the terminal 20C, which are terminals 20 of the user A and the user B included in the desired (or alternatively, predetermined) group.

Next, at Step S5-1 and Step S5-2, in response to operations or the like performed by the user A and by the user B, the display controller 213 of each of the terminal 20B and the terminal 20C displays the content on the talk room screen of the desired (or alternatively, predetermined) group. Here, the user A is the sender of the content. Therefore, on the talk room screen of the desired (or alternatively, predetermined) group, the display controller 213 of the terminal 20B (e.g., another terminal of user A) controls the content to be displayed right-aligned. For example, the display screen illustrated in FIG. 3A is displayed on the terminal 20B as on the terminal 20A.

On the other hand, as illustrated in FIG. 3B, on the talk room screen of the desired (or alternatively, predetermined) group, the controller 213 of the terminal 20C controls the content received from the server 10 to be displayed left-aligned, and controls the display name and icon of the user A to be displayed in association with the content. In the example in FIG. 3B, similar to FIG. 3A, a message 301A and a message 303A are messages transmitted by the user A via the server 10, and a message 302A is a message transmitted by the user B. Additional information 311, additional information 312, and additional information 313 are additional information items showing the dates and times when the message 301A, the message 302A, and the message 303A were transmitted, respectively. An icon 310 and an icon 314 associated with the message 301A and the message 303A, respectively, are icons indicating the user A, who transmitted the message 301A and the message 303A.

Next, at Step S6, the receiver 210 of the terminal 20A receives an operation of canceling transmission of the content from the user A on the talk room screen of the desired (or alternatively, predetermined) group. FIG. 3C illustrates an example of a talk room screen displayed on the terminal 20A. For example, if the user A performs a long press operation on a region where the message 303A is displayed on the screen in FIG. 3A, as illustrated in FIG. 3C, the display controller 213 of the terminal 20A displays a list of actions 320 for the message 303A. Then, if a press operation is performed on a “Cancel transmission” button 322, the receiver 210 of the terminal 20A receives the operation of canceling transmission for the message 303A. Note that in response to a press operation performed on the “Delete” button 321, the controller 211 of the terminal 20A deletes the display of the message 303A only on the terminal 20A.

Note that for example, if the user A performs consecutive press operations twice on the region where the message 303A is displayed on the screen in FIG. 3A, the display controller 213 of the terminal 20A may display the display name or icon of each user who has already read the message 303A and the display name or icon of each user who has not yet read the message 303A. This allows, in the case where a certain user has already read the message, the user A to determine whether to transmit a message for apologizing for wrong transmission without canceling the transmission. Note that a “read” content means, for example, that the content has already been displayed on the talk room screen. Also, an “unread” content means, for example, that the content has not yet been displayed on the talk room screen.

Next, at Step S7, the controller 211 of the terminal 20A transmits a request to cancel the transmission of the content to the server 10 via the transceiver 212. Here, the request to cancel the transmission of the content includes the message ID of the message 303A. Note that the message ID is identification information on a content such as a message. The message ID is assigned by the server 10, for example, when a content is transmitted or received, and indicated to the terminal 20 that has transmitted or received the content. However, example embodiments are note limited thereto. In some example embodiments, the message ID may be an identifier with which a message can be identified, and may be created using a combination of the ID of the talk room in which the content was transmitted and received, the user ID of the user who transmitted the content, and the date and time when the content was transmitted and received.

Next, at Step S8, the controller 110 of the server 10 determines whether to permit cancellation of transmission, and the like. Note that the determination process will be described later.

Next, at Step S9-1, Step S9-2, and Step S9-3, the controller 110 of the server 10 forwards the request to cancel the transmission of the content via the transceiver 111, to the terminal 20A, the terminal 20B, and the terminal 20C, which are terminals 20 of the user A and the user B included in the desired (or alternatively, predetermined) group.

Next, at Step S10-1, Step S10-2, and Step S10-3, the controller 211 of each of the terminal 20A, the terminal 20B, and the terminal 20C deletes the display of the content on the talk room screen or the like in the desired (or alternatively, predetermined) group. Here, the controller 211 of each of the terminals 20 may cause the display controller 213 to display a message or the like indicating that the content has been deleted along with information of the user who canceled the transmission of the content and the date and time when the transmission was canceled.

FIG. 3D illustrates an example of a talk room screen displayed on the terminal 20A of the user A and on the terminal 20B (e.g., another terminal of user A). In the example in FIG. 3D, the display of the message 303A, the additional information 303B of the message 303A, and the list of actions 320 for the message 303A has been canceled on the display screen in FIG. 3C. Then, a display region 330 is displayed that includes the date and time when the operation of canceling the transmission was performed, and a message of “Transmission of the message has been canceled.”

Note that the controller 211 of each of the terminal 20A and the terminal 20B of the user A, who canceled the transmission of the content does not need to cancel the display of the content. Thus, in some example embodiments, the controller 211 of each of the terminal 20A and the terminal 20B may be configured to be capable of obtaining the content from the server 10. This allows, for example, the user who canceled the transmission of the content to copy the content and to transmit the copied content in another talk room originally intended as the destination.

FIG. 3E illustrates an example of a talk room screen displayed on the terminal 20C of the user B. In the example in FIG. 3E, the display of the message 303A and the additional information 313 of the message 303A has been canceled on the display screen in FIG. 3B. Then, a display region 343 is displayed that includes date and time 341 when the operation of canceling the transmission was performed, and a message 342 of “Tanaka Taro canceled transmission of the message.” Here, Tanaka Taro is a display name of the user A.

### <<Process of Canceling Transmission of Received Content>>

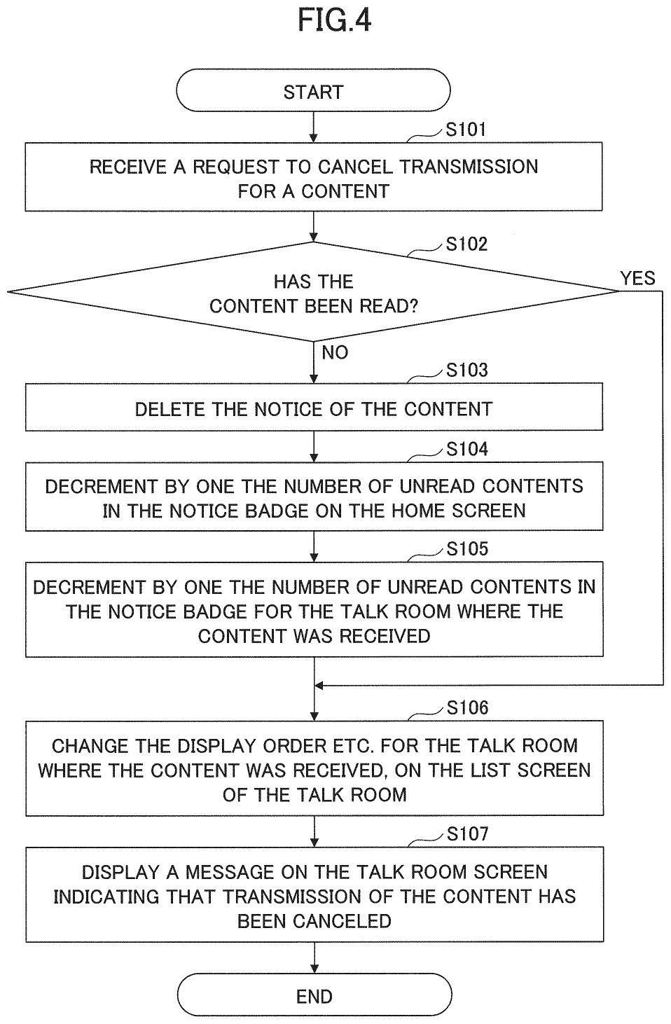

Next, with reference to FIGS. 4 to 6C, the process of canceling transmission of a received content on the terminal 20C at Step S10-3 in FIG. 2 will be described. FIG. is a flow chart illustrating an example of a process of canceling transmission of a received content according to an example embodiment in the present disclosure.

At Step S101, the controller 211 of the terminal 20C receives a request to cancel transmission of a desired (or alternatively, predetermined) content from the server 10 via the transceiver 212.

Next, at Step S102, the controller 211 of the terminal 20C determines whether the desired (or alternatively, predetermined) content has already been read. Note that if read, “Read” in the additional information with respect to the desired (or alternatively, predetermined) content on the talk room screen has been displayed by the display controller 213 of each of the terminal 20A and the terminal 20B of the user A, who transmitted the desired (or alternatively, predetermined) content. This allows, before performing an operation of canceling the transmission, the user A to determine whether the desired (or alternatively, predetermined) content has already been read by the user B.

If the desired (or alternatively, predetermined) content has already been read (YES at Step S102), the controller 211 of the terminal 20C proceeds to Step S106, which will be described later.

On the other hand, if the desired (or alternatively, predetermined) content is not read (unread) (NO at Step S102), at Step S103, the controller 211 of the terminal 20C deletes a notice of the desired (or alternatively, predetermined) content using a function or the like of an OS (Operating System).

Note that at Step S4-2 in FIG. 2, when the desired (or alternatively, predetermined) content is received from the server 10, the controller 211 of the terminal 20C uses a notice function of the OS to turn on the terminal 20C screen, to display on a home screen or lock screen a notice including the desired (or alternatively, predetermined) content on a region such as the top of the screen. Then, the controller 211 of the terminal 20C turns off the screen after a desired (or alternatively, predetermined) period (e.g., 10 seconds) has elapsed. The notice is displayed on the screen again, for example, when the user B turns on the terminal 20C to display the lock screen, or when a desired (or alternatively, predetermined) operation has been performed on the home screen. Then, in the case where the desired (or alternatively, predetermined) content becomes read (e.g. where the desired (or alternatively, predetermined) content has been displayed on the talk room screen by an operation performed by the user B), the controller 211 of the terminal 20C deletes the notice. Note that the home screen is a screen, for example, when an application is not activated on the terminal 20, and may be referred to as a standby screen or a desktop screen. For example, in the case where user authentication has succeeded on the lock screen, the home screen is displayed.

Therefore, if the desired (or alternatively, predetermined) content has not been, the notice has not been deleted. Therefore, the notice including the desired (or alternatively, predetermined) content may be read by the user B. Thereupon, by executing Step S103, the controller 211 of the terminal 20C deletes the notice. Note that the notice of the desired (or alternatively, predetermined) content described above is an example of an “object indicating that a content is unread.”

Next, at Step S104, the controller 211 of the terminal 20C decrements by one the number of unread contents in a notice badge, for example, as an icon of the application of instant messaging service on the home screen.

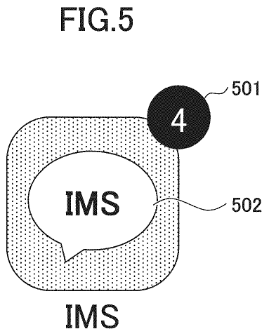

FIG. 5 is a diagram illustrating an example of a notice badge on a home screen of the terminal 20C. In the example in FIG. 5, on the home screen of the terminal 20C, in a notice badge 501 at the upper right corner of the icon 502 of the application of instant messaging service, “4” is displayed as the number of unread contents among received contents. In this case, by executing Step S104, the number is displayed as “3.”

Next, at Step S105, the controller 211 of the terminal 20C decrements by one the number of unread contents in the notice badge with respect to the talk room in which the desired (or alternatively, predetermined) content was received. Note that in the case where the number of unread contents reaches zero, the controller 211 of the terminal 20C may delete the display of the notice badge.

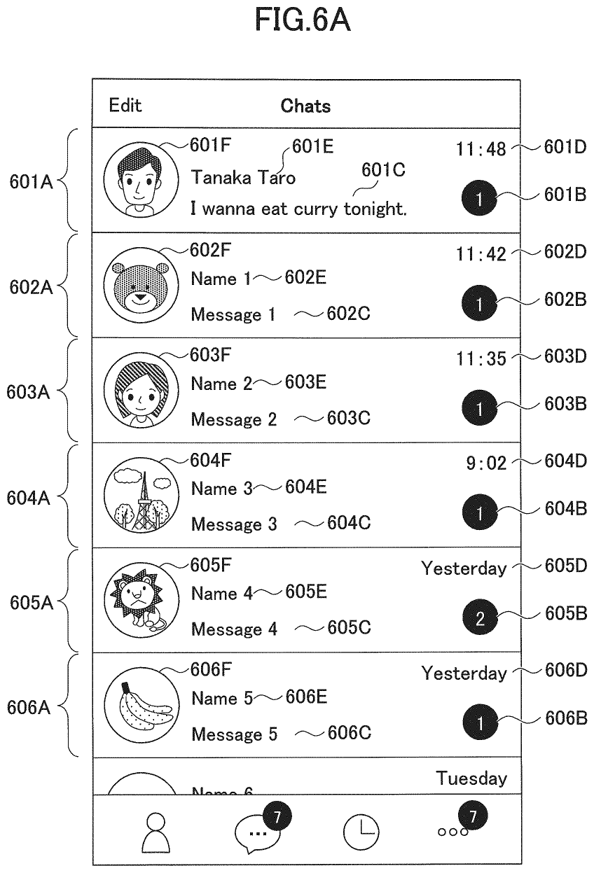

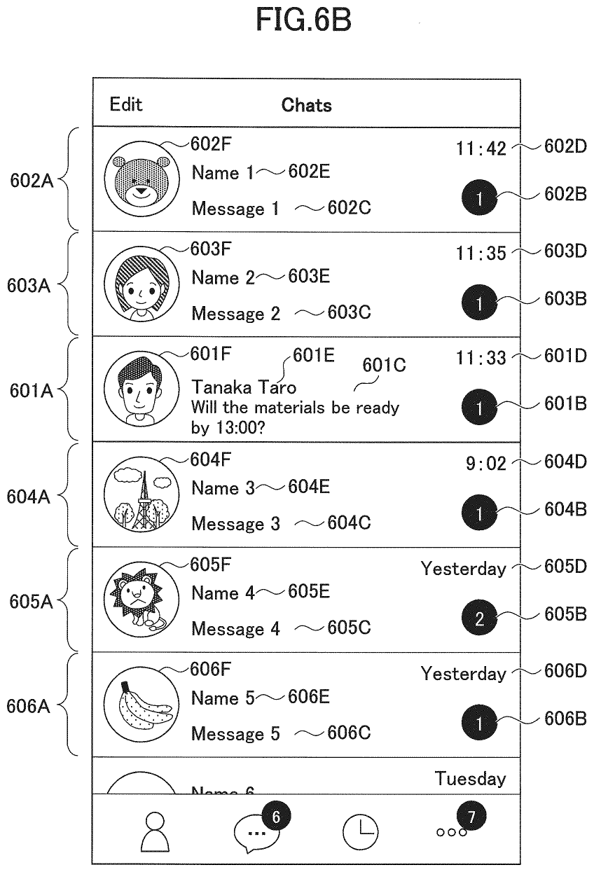

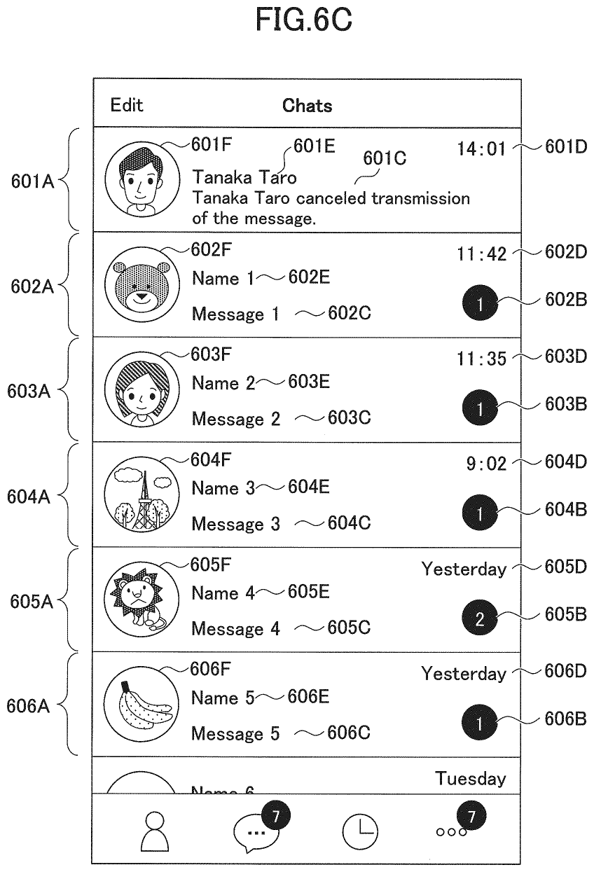

FIGS. 6A to 6C are diagrams illustrating examples of list screens of talk rooms displayed on the terminal 20C. Until the user A performs an operation of canceling the transmission of the message 303A in FIG. 3C, if the user B activates the application for instant messaging service, and performs an operation of displaying a list screen of talk rooms (list screen of groups related to talk rooms) on the terminal 20C, a screen in FIG. 6A is displayed.

In the example in FIG. 6A, in association with talk rooms 601A to 606A, notice badges 601B to 606B for the respective talk rooms, and contents 601C to 606C transmitted and received most recently in the respective talk rooms are displayed. Also, dates and times 601D to 606D when the contents 601C to 606C were transmitted and received, display names 601E to 606E of one or more users other than the user C of terminal 20C among users included in the groups of the respective talk rooms, and icons 601F to 606F of these one or more users, are displayed.

In the notice badge 601B, the number of unread contents in the talk room 601A is displayed as “1.” In the case of the talk room 601A being a talk room in which transmission of a content was canceled, executing Step S105 causes the display of the notice badge 601B to disappear or the number to be displayed as “0.”

Note that in the case where the desired (or alternatively, predetermined) content becomes read as the desired (or alternatively, predetermined) content has been displayed on the talk room screen by an operation performed by the user B, the controller 211 of the terminal 20C decrements by one the number of unread contents in the notice badge with respect to the talk room in which the desired (or alternatively, predetermined) content was received. Note that the value of the number of unread contents in a notice badge and the notice badge are examples of an “object indicating an unread content.”

Note that in the example in FIG. 6A, if the talk room 601A is pressed by the user B, a screen in FIG. 3B is displayed. In the example in FIG. 6A, the content 601C transmitted and received most recently in the talk room 601 is the message 303A in FIG. 3C.

Next, at Step S106, on the list screen of talk rooms, with respect to the talk room in which the desired (or alternatively, predetermined) content has been received, the controller 211 of the terminal 20C changes the content transmitted and received most recently, the date and time when the content was transmitted and received, and the display order of the talk room was displayed, depending on the content whose transmission was canceled, and ends the process. Here, for example, in response to receiving the desired (or alternatively, predetermined) content, the controller 211 of the terminal 20C changes, on the list screen of talk rooms, the display order of the talk room in which the desired (or alternatively, predetermined) content was transmitted and received, to the top of the list screen. Then, in response to receiving a request to cancel the transmission of the desired (or alternatively, predetermined) content, the terminal 20C changes, on the list screen, the display order of the talk room to the order before the change described above.

FIG. 6B is a diagram illustrating an example of the list screen of talk rooms after the change. If the user A has performed an operation of canceling the transmission of the message 303A in FIG. 3C, and then if the user B performs an operation of displaying the list screen of talk rooms on the terminal 20C, a screen in FIG. 6B is displayed.

In the case where the transmission of the message 303A in FIG. 3C is canceled, the controller 211 of the terminal 20C changes the content 601C transmitted and received most recently in the talk room 601 to the message 302A in FIG. 3C, as illustrated in FIG. 6B. Also, the controller 211 of the terminal 20C changes the date and time 601D when the content 601C was transmitted and received, to the date and time included in the additional information 302B with respect to the message 302A in FIG. 3C.

Also, on the list screens of talk rooms in FIGS. 6A and 6B, the controller 211 of the terminal 20C arranges the talk rooms in order based on date and time such that a talk room having newer date and time with respect to the content transmitted and received most recently in the talk room, is displayed closer to the top of the screen. In the example in FIG. 6A, the date and time 601D when the content 601C was transmitted and received most recently in the talk room 601 is newer than those of the other talk rooms. Therefore, the talk room 601 is displayed at the top (upmost) position on the list of talk rooms. In the example in FIG. 6B, the date and time 601D when the content 601C was transmitted and received most recently in the talk room 601 is the 3rd newest among all talk rooms. Therefore, the talk room 601 is displayed at the 3rd position from the top on the list of talk rooms.

Note that in the case where the desired (or alternatively, predetermined) content has already been read, in response to a message indicating that the transmission of the desired (or alternatively, predetermined) content has been canceled, the controller 211 of the terminal 20C may change the display order of the talk room in the list screen of talk rooms. In this case, for example, on the terminal 20C, in the case where the message 303A has already been displayed on the talk room screen as in FIG. 3B, and the user B performs an operation of displaying the list screen of talk rooms on the terminal 20C, the controller 211 of the terminal 20C may display the screen in FIG. 6C. In the example in FIG. 6C, the controller 211 of the terminal 20C displays a screen in which the display of the notice badge 601B has been deleted or the number is displayed as “0”, as compared to the screen in FIG. 6A. Also, the controller 211 of the terminal 20C changes the content 601C transmitted and received most recently in the talk room 601, to the message 342 of “Tanaka Taro canceled transmission of the message” in FIG. 3E, and also changes the date and time 601D when the content 601C was transmitted and received, to date and time 341 when the operation to cancel the transmission in FIG. 3E was performed. In the example in FIG. 6C, as in FIG. 6A, the date and time 601D when the content 601C was transmitted and received most recently in the talk room 601 is newer than those of the other talk rooms. Therefore, the talk room 601 is displayed at the top on the list of talk rooms.

Next, at Step S107, the controller 211 of the terminal 20C displays on the talk room screen a message indicating that transmission of the desired (or alternatively, predetermined) content has been canceled, and ends the process. Here, in response to receiving an operation of displaying the talk room screen of the talk room 601 from the user B, the controller 211 of the terminal 20C displays a region 343, in which the date and time 341 when the operation of canceling transmission was performed, and the message 342 of “Tanaka Taro canceled the transmission of the message” are displayed as illustrated in FIG. 3D.

Note that in the case where the transmission of the desired (or alternatively, predetermined) content is canceled, and the desired (or alternatively, predetermined) content is unread on the terminal 20C, the controller 211 of the terminal 20C may hide the message on the talk room screen. On the other hand, in the case where the desired (or alternatively, predetermined) content has already been displayed on the talk room screen, the controller 211 of the terminal 20C may display on the talk room screen a message indicating that the desired (or alternatively, predetermined) content has been canceled. This enables not to inform of a user who has not yet read the desired (or alternatively, predetermined) content that the desired (or alternatively, predetermined) content has been transmitted, and enables to inform of a user who has already read the content that the transmission has been canceled.

### <Modified Example in the Case of Read>

Note that in the case where the desired (or alternatively, predetermined) content has already been displayed on the talk room screen when transmission of the desired (or alternatively, predetermined) content is canceled, and, the controller 211 of the terminal 20C may perform the following processing.

The controller 211 of the terminal 20C may display, for example, the remaining time to cancel the display of the desired (or alternatively, predetermined) content (a countdown timer) on the talk room screen, and once the remaining time reaches zero, the display of the desired (or alternatively, predetermined) content may be deleted. This allows the user to clearly recognize the remaining time until the message is deleted.

In some example embodiments, the controller 211 of the terminal 20C may reduce the visibility of the desired (or alternatively, predetermined) content on the talk room screen, for example, by shading the desired (or alternatively, predetermined) content, or may gradually reduce the visibility of the desired (or alternatively, predetermined) content by increasing the shading as time elapses. This allows the user to intuitively recognize a process of deleting the desired (or alternatively, predetermined) content. Note that when the visibility of the desired (or alternatively, predetermined) content has become reduced to an extent that it is difficult for the user to recognize the desired (or alternatively, predetermined) content, it may be stated that the desired (or alternatively, predetermined) content has transitioned to a hidden (deleted) state.

In some example embodiments, the controller 211 of the terminal 20C may replace the desired (or alternatively, predetermined) content, for example, with a content or object different from the desired (or alternatively, predetermined) content, and display the replacement. In this case, the controller 211 of the terminal 20C may replace the desired (or alternatively, predetermined) content, for example, with a desired (or alternatively, predetermined) stamp, a desired (or alternatively, predetermined) message, a desired (or alternatively, predetermined) icon, or the like, and display the replacement. In this case, the different content or the like may be a content or the like specified by the user A, who performs an operation of canceling the transmission on the terminal 20A.

### <Process of Determining Whether to Permit Cancellation of Transmission>

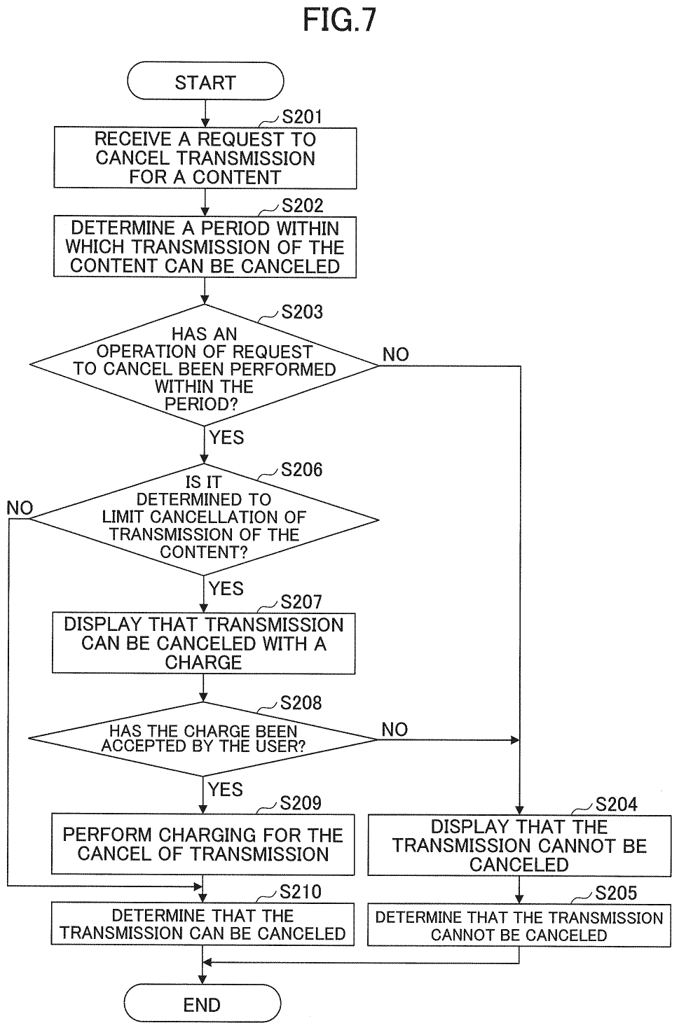

Next, with reference to FIG. 7, an example of a process of determining whether to permit cancellation of transmission performed by the controller 110 of the server 10 at Step S8 in FIG. 2 will be described. Note that the following processing may be performed by the controller 211 of the terminal 20. FIG. 7 is a flow chart illustrating an example of a process of determining whether to permit cancellation of transmission according to an example embodiment in the present disclosure.

At Step S201, the controller 110 of the terminal 20C receives a request to cancel transmission of a desired (or alternatively, predetermined) content from the server 10 via the transceiver 111.

(Determination of a Period of Time within which Transmission Can Be Canceled)

Next, at Step S202, the controller 110 of the server 10 determines a period of time and the number of times within which transmission of the desired (or alternatively, predetermined) content can be canceled. The period of time and the number of times within which transmission can be canceled are provided because, for example, if it is possible to cancel transmission even after a certain period has elapsed, usability as a communication history may become worse unexpectedly. Note that at Step S202, the controller 110 of the server 10 may determine only one of the period of time or the number of times.

Here, the controller 110 of the server 10 may set a period starting from the time when the desired (or alternatively, predetermined) content was transmitted or received, until a desired time, a time set in advance (e.g., 24 hours), or a time set in advance by the user who cancels the transmission elapses, as the period of time within which the transmission can be canceled. For example, the controller 110 of the server 10 may set, for example, in advance the number of times within which transmission can be canceled set for each of the users of the terminals 20 or for each of the users of the terminals 20 and each talk room within a desired (or alternatively, predetermined) period (e.g., one month), as the number of times within which the transmission can be canceled.

In some example embodiments, the controller 110 of the server 10 may determine a period of time and the number of times within which transmission of the desired (or alternatively, predetermined) content can be canceled, based on at least one of the number of users registered as having a desired (or alternatively, predetermined) relationship by the user who canceled transmission, the number of contents transmitted and received by the user, a time period from the time when the account of the user was opened to the present time, the number of cancellations of transmission made by the user, a time period within which contents are transmitted and received, a subject matter of the content for which a cancellation request is made, the number of users commonly registered as having a desired (or alternatively, predetermined) relationship, by the users included in a group related to a talk room in which the content to be canceled is transmitted and received, a time period during which the users have registered one another as having a desired (or alternatively, predetermined) relationship, and the frequency with which contents are transmitted and received among the users.

((Credit Level of Account, Etc.))

In some example embodiments, the controller 110 of the server 10 may determine a period of time and the number of times within which transmission of the desired (or alternatively, predetermined) content can be canceled, based on data in the account information 151 associated with the user of the terminal 20 who transmits the request to cancel the transmission. This allows to set a longer period of time within which transmission can be canceled, and to set a greater number of times within which transmission can be canceled, for example, for a user who has a higher credit level (reliability).

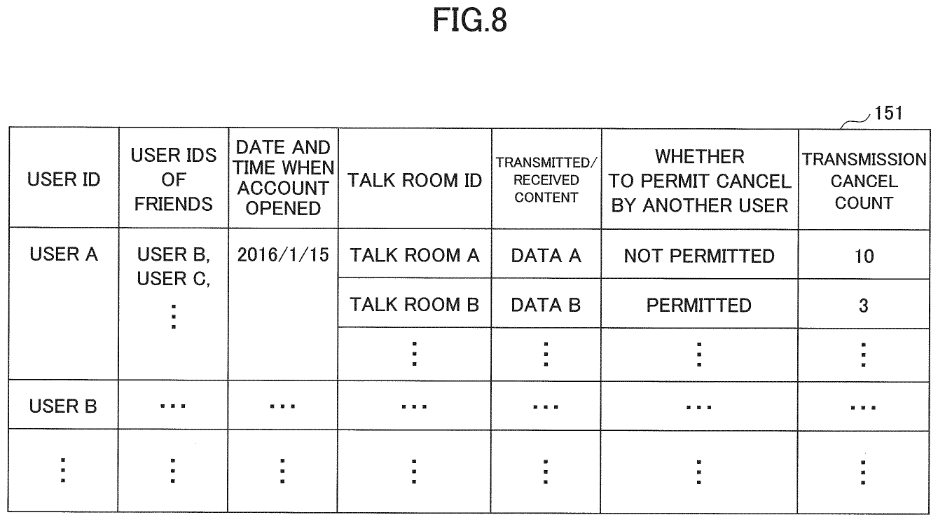

FIG. 8 is a diagram illustrating an example of the account information 151. In the example in FIG. 8, in the account information 151, in association with the user ID, the user IDs of friends (an example of a “desired (or alternatively, predetermined) relationship”), date and time when the account was opened, and one or more talk room IDs are stored. Further, in association with each talk room ID, transmitted/received content, whether to permit cancellation by another user, and transmission cancel count are stored.

The user ID is identification information on the user of the terminal 20. The user ID of a friend is a user ID of a user registered as a friend by the user of the terminal 20. The date and time when the account was opened is the date and time when the account of the user related to the user ID was opened on the server 10 by the user. Note that once an account of a user is opened, data of the user is stored in the account information 151.

The talk room ID is identification information on a talk room related to the terminal 20. The talk room ID may be a user ID among one or more users other than the user of the terminal 20 included in a group related to the talk room.

The transmitted/received content is data of a content transmitted and received in the talk room related to the talk room ID, and includes data of the content itself, the user ID of the user who transmitted the content, the date and time when the content was transmitted or received, data indicating whether the content has been displayed on the talk room screen, and the like.

Whether to permit cancellation by another user is data specifying whether to permit another user to cancel transmission of the content received by the terminal 20 in the talk room related to the talk room ID. Whether to permit cancellation by another user may be set by, for example, the user of the terminal 20.

The transmission cancel count is the number of times the user of the terminal 20 has canceled transmission of contents transmitted by the user of the terminal 20 or the other users in the talk room related to the talk room ID.

Note that whether to permit cancellation by another user may be stored for each user ID. In this case, whether to permit cancellation by another user is data specifying whether to permit another user to cancel transmission of the content transmitted by the user of the terminal 20, in all talk rooms that include the user of the terminal 20. Also, the transmission cancel count may be stored for each user ID. In this case, the transmission cancel count is the sum of the number of times the user of the terminal 20 has canceled transmission of contents transmitted by the user of the terminal 20 or the other users in every talk room including the user of the terminal 20.

The controller 110 of the server 10 may determine a longer period of time within which the desired (or alternatively, predetermined) content can be canceled, and may determine a relatively great number of times within which transmission can be canceled, for example, for a greater number of users registered as friends of the user of the terminal 20.

In some example embodiments, the controller 110 of the server 10 may determine a longer period of time within which the desired (or alternatively, predetermined) content can be canceled, and may determine a relatively great number of times within which transmission can be canceled, for a greater amount of use since the account of the user of the terminal 20 was opened until the present time, or for a greater frequency of use since the account of the user of the terminal 20 was opened until the present time. In this case, for example, one or both of the number of transmitted contents and the number of received contents may be used as the amount of use. Also, for example, one or both of the frequency with which contents have been transmitted and the frequency with which contents have been received may be used as the frequency of use.

In some example embodiments, the controller 110 of the server 10 may determine a longer period of time within which the desired (or alternatively, predetermined) content can be canceled, and may determine a relatively great number of times within which transmission can be canceled, for a longer period starting from the time when the account was opened until the present time. This enables, for example, to avoid a case such that a user included in a group related to a talk room newly opens a sub-account, invites the sub-account to the talk room, and relatively often cancels transmission of contents transmitted and received in the talk room using the sub-account.

((Use History of Function of Canceling Transmission))

In some example embodiments, the controller 110 of the server 10 may determine a period of time and the number of times within which transmission of the desired (or alternatively, predetermined) content can be canceled by the user, based on the number or frequency of operations of canceling transmission performed by the user of the terminal 20. In this case, the controller 110 of the server 10 may determine a longer period of time within which the desired (or alternatively, predetermined) content can be canceled, and may determine a relatively great number of times within which transmission can be canceled for the user of the terminal 20, for example, for a greater number or higher frequency of operations of canceling transmission performed by the user. In this case, the controller 110 of the server 10 may set a relatively long period and a relatively great number of times for transmission canceling for a user who has relatively often performed wrong transmission.

In some example embodiments, the controller 110 of the server 10 may determine a period of time and the number of times within which transmission of the desired (or alternatively, predetermined) content can be canceled in each talk room, based on the number or frequency of operations of canceling transmission performed by the user of the terminal in the talk room. In this case, the controller 110 of the server 10 may set a relatively long period and a relatively great number of times for transmission canceling in a desired (or alternatively, predetermined) talk room for a user who has relatively often performed wrong transmission in the desired (or alternatively, predetermined) talk room. ((Time Period))

In some example embodiments, the controller 110 of the server 10 may determine a period of time and the number of times within which transmission of the desired (or alternatively, predetermined) content can be canceled, based on a time period within which the user of the terminal 20 has performed a transmission operation of a desired (or alternatively, predetermined) content. In this case, for example, in the case where the desired (or alternatively, predetermined) content was transmitted or received at night, the controller 110 of the server 10 may determine a relatively long period of time within which transmission can be canceled for the desired (or alternatively, predetermined) content, and determine a great number of times within which the transmission can be canceled. This enables, for example, to permit to cancel transmission for a relatively long period and a relatively great number of times, for a content transmitted and received within hours during which wrong transmission is likely to happen.

((Subject Matter of Content))

In some example embodiments, the controller 110 of the server 10 may determine a period of time and the number of times within which transmission of the desired (or alternatively, predetermined) content can be canceled, based on the subject matter of the desired (or alternatively, predetermined) content. In this case, for example, in a talk room in which a desired (or alternatively, predetermined) content has been transmitted and received, in the case where the ratio of messages including polite words transmitted by the user of the terminal 20 is greater than or equal to a desired (or alternatively, predetermined) threshold, and the desired (or alternatively, predetermined) content transmitted by the user does not include polite words, the controller 110 of the server 10 may determine a relatively long period of time within which the desired (or alternatively, predetermined) content can be canceled, and may determine a relatively great number of times within which transmission can be canceled.

In some example embodiments, in the case where a transmitted desired (or alternatively, predetermined) content includes a desired (or alternatively, predetermined) phrase such as an improper keyword, the controller 110 of the server 10 may determine a relatively long period of time within which transmission of the desired (or alternatively, predetermined) content can be canceled and a relatively great number of times within which the transmission can be canceled. In this case, the controller 110 of the server 10 may set a relatively long period of time within which transmission can be canceled for a content, for example, that is highly likely to be wrong transmission, and set a relatively great number of times within which the transmission can be canceled for a user or the like who has transmitted the content. Note that the controller 110 of the server 10 may make such a function of determining a period of time and the like within which transmission of a desired (or alternatively, predetermined) content can be canceled based on the subject matter of the desired (or alternatively, predetermined) content, available for the user, for example, only when approved by the user.

((Intimacy with the Other Users))

In some example embodiments, the controller 110 of the server 10 may determine a period of time and the number of times within which transmission of the desired (or alternatively, predetermined) content can be canceled, based on the intimacy between the user of the terminal 20 and the other users. In this case, in the case where the intimacy among multiple users included in a group related to a talk room is higher, the controller 110 of the server 10 may determine a relatively long period of time within which transmission can be canceled for the desired (or alternatively, predetermined) content, and determine a relatively great number of times within which the transmission can be canceled by the multiple of users, and in the talk room. This enables, for example, to cancel wrong transmission to the other highly-intimate users more easily.

For example, the controller 110 of the server 10 may determine the intimacy to be higher, for example, for a greater number of users (common friends) commonly registered as friends by the user of the terminal 20 and by the other users. For example, the controller 110 of the server 10 may determine the intimacy to be higher, for example, for a higher ratio of the number of common friends to the total number of users registered as friends by the user of the terminal 20, and for a higher ratio of the number of common friends to the total number of users registered as friends by the other users.

The controller 110 of the server 10 may determine the intimacy to be further higher, for example, for a longer period during which the user of the terminal 20 and the other user are set as friends. In this case, the controller 110 of the server 10 may set as the period, for example, a length starting from the date and time when at least one of the user of the terminal 20 and the other user registered the counterpart as a friend until the present date and time.

The controller 110 of the server 10 may determine the intimacy to be further higher, for example, for a higher frequency of transmission and reception of contents between the user of the terminal 20 and the other user.

Next, at Step S203, the controller 110 of the server 10 determines whether an operation of requesting to cancel the transmission of the desired (or alternatively, predetermined) content was performed within the period of time and within the number of times. Here, for example, if a request to cancel the transmission of the desired (or alternatively, predetermined) content has been received within the period, the controller 110 of the server 10 may determine that the operation was performed within the period.

If the operation has not been performed within the period (NO at Step S203), at Step S204, the controller 110 of the server 10 displays a message indicating that the transmission cannot be canceled on the screen of the terminal that has transmitted the request to cancel the transmission, then at Step S205, determines that the transmission cannot be canceled, and ends the process. Here, the controller 110 of the server 10 may display a message indicating that the period has expired, on the screen of the terminal 20.

If the operation has been performed within the period (YES at Step S203), at Step S206, the controller 110 of the server 10 determines whether to limit cancellation of the transmission of the desired (or alternatively, predetermined) content.

Here, the controller 110 of the server 10 may determine whether to limit cancellation of the transmission of the desired (or alternatively, predetermined) content, depending on a setting of whether to permit the user of the terminal 20 who receives the desired (or alternatively, predetermined) content to cancel the transmission. In this case, the setting may be stored in the item “whether to permit cancel by another user” in the account information 151. This allows the user, for example, to prevent a content received on the terminal 20 of the user, from being deleted by an operation of canceling the transmission performed by another user.

In some example embodiments, the controller 110 of the server 10 may temporarily suspend cancellation of transmission by the user of the terminal 20 upon a notice from the user.

In some example embodiments, the controller 110 of the server 10 may permit cancellation of transmission of the desired (or alternatively, predetermined) content, in the case where the desired (or alternatively, predetermined) content has not yet been read by all users in the group related to the talk room except for the user who has transmitted the desired (or alternatively, predetermined) content.

In the case of not limiting cancellation of the transmission (NO at Step S206), the process proceeds to Step S210, which will be described later. In the case of limiting cancellation of the transmission (YES at Step S206), at Step S207, a message indicating that transmission can be canceled with a charge is displayed on the screen of the terminal 20 that has transmitted the request to cancel the transmission.

Next, the controller 110 of the server 10 determines whether or not an operation of approving the charge has been received from the user of the terminal 20 (Step S208), and if the operation of approval has not been received (NO at Step S208), proceeds to Step S204.

On the other hand, if having received the operation of approval (YES at Step S208), in response to the operation of approving the charge from the user of the terminal 20, at Step S209, the controller 110 of the server 10 performs charging for the cancellation of the transmission, then at Step S210, determines that the transmission can be canceled, and ends the process. Note that in the case of limiting cancellation of the transmission (YES at Step S206), the process may proceed to Step S204 instead of proceeding to Step S207.

In some example embodiments, in the case where the user of the terminal 20 has purchased a content including a stamp, a cartoon, and music on the server 10, the controller 110 of the server 10 may permit the user to cancel transmission within a desired (or alternatively, predetermined) number of times without charging. The controller 110 of the server 10 may determine the desired (or alternatively, predetermined) number of times within which the user can cancel transmission, based on, for example, the amount of charge, the number of times of charging, and the like on the account used by the user.

### <Modified Example of Process of Determining Whether to Permit Cancellation of Transmission>

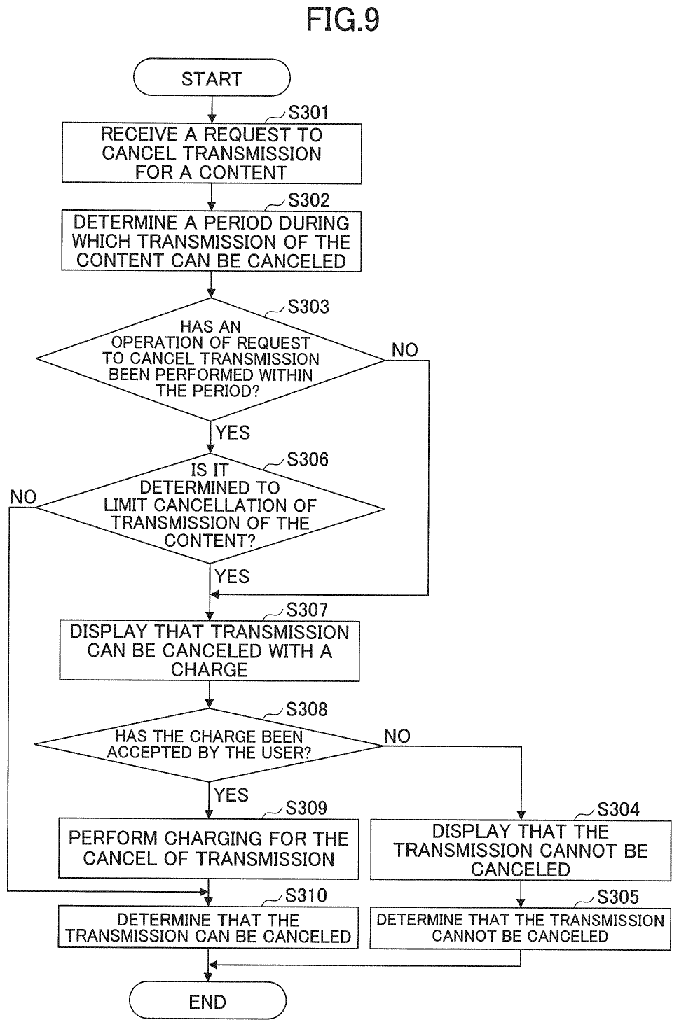

Next, with reference to FIG. 9, an example of a process of determining whether to permit cancellation of transmission performed by the controller 110 of the server 10 at Step S8 in FIG. 2 will be described. FIG. 9 is a flow chart illustrating an example of a process of determining whether to permit cancellation of transmission according to an example embodiment in the present disclosure. Processing at Steps S301 through S310 in FIG. 9 is the same or substantially similar to processing at Steps S201 through S210 in FIG. 7 described above. In the following, points that differ from FIG. 7 will be described.

In the example in FIG. 9, at Step S303, if the operation has not been performed within a period of time within which the transmission be canceled (NO at Step S303), the process proceeds to Step S307, and a message indicating that the transmission can be canceled with a charge is displayed on the screen of the terminal 20 that has transmitted the request to cancel the transmission. This allows, even if the period of time or the number of times within which the transmission can be canceled has expired or exceeded, the user to cancel the transmission.

In the charging process at Step S309 in FIG. 9, the controller 110 of the server 10 may set the amount of charge according to the elapsed time after the period of time within which the transmission can be canceled until the present time. The controller 110 of the server 10 may set the amount of charge higher, for example, for a longer elapsed time.

In some example embodiments, the controller 110 of the server 10 may set the amount of charge higher in proportion to the number of times of cancellations of transmission exceeding the allowed number of times of cancellations of transmission. The controller 110 of the server 10 may set the amount of charge higher, for example, for a greater number of times in excess.

In some example embodiments, the controller 110 of the server 10 may set the amount of charge higher depending on the number of users included in a group related to a talk room in which the transmission was canceled. The controller 110 of the server 10 may set the amount of charge higher, for example, for a greater number of the other users. Also, the controller 110 of the server 10 may determine the amount of charge based on a desired (or alternatively, predetermined) function.

### <Effects of Example Embodiments>

According to the disclosed techniques, in a group that includes multiple users, in the case where a content has been wrongly transmitted, or a transmitted and received content is inappropriate, the content received on the terminal 20 of one user can be deleted by an operation performed on the terminal 20 of another user.

According to the disclosed techniques, communication such as apologies for wrong transmission can be reduced. Therefore, it is possible to improve the convenience of the users, and to reduce operations performed by the users. Accordingly, the number of operations on the terminal 20 and the number of communications between the terminal 20 and the server 10 can be reduced, thereby reducing the load and the number of communications on the terminal 20 and the server 10.

Although some example embodiments in the present disclosure have been described based on the drawings and some application examples, it should be noted that those skilled in the art will find it easy to make various modifications and alterations based on the present disclosure. Therefore, it should be noted that transformations and modifications are within the scope of the present disclosure. By way of example but not as a limitation, the functions or the like included in functional units, steps, and the like are relocatable as long as not introducing logical contradiction, and multiple functional units, steps, and the like can be combined into one entity, or can be further divided. Also, the elements described in the respective embodiments may be appropriately combined. Note that the server 10 and the terminal 20 are examples of an “information processing apparatus.”

What is claimed is:

1. A non-transitory computer-readable recording medium having computer-readable instructions stored thereon, which when executed, cause an information processing apparatus that includes a memory and a processor, to execute a process comprising:
receiving a first content in a first group including a first user and a second user;
displaying one or more contents including the first content transmitted and received in the first group on a screen; and
hiding the first content from among the one or more contents transmitted and received in the first group in response to receiving a request to cancel transmission of the first content from the first user.

2. The non-transitory computer-readable recording medium as claimed in claim 1, wherein the process further comprises:
displaying an object indicating that the first content is unread on the screen in response to the receiving the first content; and
hiding the object associated with the first content that has not been read on the screen, in response to the receiving the request to cancel the transmission of the first content from the first user.

3. The non-transitory computer-readable recording medium as claimed in claim 1, wherein the process further comprises:
changing a display order of the first group to a top on a list screen of a plurality of groups in response to the receiving the first content in the first group; and
changing the display order of the first group to the display order before the changing to the top on the list screen in response to the receiving the request to cancel the transmission of the first content.

4. The non-transitory computer-readable recording medium as claimed in claim 1, wherein the hiding the first content includes:
hiding the first content on a list screen including the one or more contents transmitted and received in the first group; and
displaying at least one of the first user making the request to cancel the transmission of the first content or date or time of the request to cancel the transmission of the first content on the list screen.

5. The non-transitory computer-readable recording medium as claimed in claim 1, wherein the hiding the first content includes:
displaying a message indicating that the first content has been hidden on a list screen of the one or more contents transmitted and received in the first group, for the second user in response to the second user having read the first content; and
hiding the message on the list screen for the second user in response to the second user having not read the first content.

6. The non-transitory computer-readable recording medium as claimed in claim 1, wherein the hiding the first content includes decreasing visibility of the first content as time elapses or replacing the first content with another content or object, on a list screen of the one or more contents transmitted and received in the first group.

7. The non-transitory computer-readable recording medium as claimed in claim 1, wherein the process further comprises:
determining a period of time within which the first user can cancel the transmission of the first content, based on at least one of a number of users registered as having a relationship by the first user, a number of contents transmitted and received by the first user, a time period from a time of opening an account of the first user to a present time, a number of cancellations of transmission made by the first user, a time period within which the first content has been transmitted and received, a subject matter of the first content, a credit level of the first user, a number of users registered as having a relationship by both the first user and the second user, a time period during which the first user and the second user have been registered as having a relationship, or a frequency with which contents have been transmitted and received between the first user and the second user.

8. The non-transitory computer-readable recording medium as claimed in claim 1, wherein the process further comprises:
limiting the request to cancel the transmission of the first content, based on at least one of a setting whether to permit the second user to cancel the transmission, a number of users registered as having a relationship by the first user, a number of contents transmitted and received by the first user, a time period from a time of opening an account of the first user to a present time, or a number of cancellations of transmission made by the first user.

9. The non-transitory computer-readable recording medium as claimed in claim 1, wherein the process further comprises:
charging for the request to cancel the transmission of the first content, based on a condition.

10. The non-transitory computer-readable recording medium as claimed in claim 9, wherein the condition includes at least one of a number of cancellations of transmission made by the first user, a setting whether to permit the second user to cancel the transmission, an elapsed time after expiration of a time period, or a number of users included in the first group.

11. A non-transitory computer-readable recording medium having computer-readable instructions stored thereon, which when executed, cause an information processing apparatus that includes a memory and a processor, to execute a process comprising:
receiving a first content in a first group including a first user and a second user via another information processing apparatus connected via a network;
storing the first content, and displaying one or more contents including the first content transmitted and received in the first group on a screen; and
deleting the first content that has been stored, in response to receiving a request to cancel transmission of the first content from the first user.

12. A non-transitory computer-readable recording medium having computer-readable instructions stored thereon, which when executed, cause an information processing apparatus that includes a memory and a processor, to execute a process comprising:
transmitting or receiving a first content in a first group including a first user and a second user via another information processing apparatus connected via a network;
transmitting a request to cancel transmission of the first content from the first user, via said another information processing apparatus; and
deleting the first content that has been stored, from among one or more contents transmitted and received in the first group, in response to receiving the request to cancel the transmission from said another information processing apparatus.

13. The non-transitory computer-readable recording medium as claimed in claim 12, wherein the process further comprises:
displaying at least one of a user who has read the first content or a user who has not read the first content, on a list screen of the one or more contents transmitted and received in the first group in response to the receiving the request to cancel the transmission.

14. An information processing method performed by an information processing apparatus including a memory and a processor, the method comprising:
receiving a first content in a first group including a first user and a second user;
displaying one or more contents including the first content transmitted and received in the first group on a screen; and
hiding the first content from among the one or more contents transmitted and received in the first group in response to receiving a request to cancel transmission of the first content from the first user.

15. An information processing apparatus comprising:
a memory configured to store computer-readable instructions; and
a processor configured to execute the computer-readable instructions such that the processor is configured to cause the information processing apparatus to,
receive a first content in a first group including a first user and a second user,
display one or more contents including the first content transmitted and received in the first group on a screen, and
hide the first content from among the one or more contents transmitted and received in the first group in response to receiving a request to cancel transmission of the first content from the first user.
